(19) United States
(12) Patent Application Publication
(10) Pub. No.: US 2018/0288557 A1
(43) Pub. Date: Oct. 4, 2018

(54) USE OF EARCONS FOR ROI IDENTIFICATION IN 360-DEGREE VIDEO

(71) Applicant: Samsung Electronics Co., Ltd., Suwon-si (KR)

(72) Inventors: Hossein Najaf-Zadeh, Allen, TX (US); Madhukar Budagavi, Plano, TX (US)

(21) Appl. No.: 15/890,113

(22) Filed: Feb. 6, 2018

Related U.S. Application Data
(60) Provisional application No. 62/478,261, filed on Mar. 29, 2017.
(60) Provisional application No. 62/507,286, filed on May 17, 2017.
(60) Provisional application No. 62/520,739, filed on Jun. 16, 2017.
(60) Provisional application No. 62/530,766, filed on Jul. 10, 2017.
(60) Provisional application No. 62/542,870, filed on Aug. 9, 2017.

(51) Int. Cl. H04S 7/00; H04N 21/4728; G06F 3/01; G06T 19/00; H04S 1/00

(52) U.S. Cl. CPC H04S 7/303; H04N 21/4728; H04S 1/007; G06T 19/003; G06F 3/011

(57) ABSTRACT

An electronic device, a method and computer readable medium for indicating a region of interest within an omnidirectional video content are disclosed. The method includes receiving receiving metadata for the region of interest in the omnidirectional video content. The metadata includes an earcon for the region of interest, timing information for the region of interest, and position information for the region of interest. The method also includes displaying a portion of the omnidirectional video content on a display. The method further includes determining whether to play the earcon to indicate the region of interest based on the timing and position information for the region of interest and the portion of the omnidirectional video content displayed on the display. The method also includes playing audio for the earcon to indicate the region of interest.

### CROSS-REFERENCE TO RELATED APPLICATION AND CLAIM OF PRIORITY

This application claims priority under 35 U.S.C. § 119(e) to U.S. Provisional Patent Application No. 62/478,261 filed on Mar. 29, 2017; U.S. Provisional Patent Application No. 62/507,286 filed on May 17, 2017; U.S. Provisional Patent Application No. 62/520,739 filed on Jun. 16, 2017; U.S. Provisional Patent Application No. 62/530,766 filed on Jul. 10, 2017; and U.S. Provisional Patent Application No. 62/542,870 filed on Aug. 9, 2017. The above-identified provisional patent applications are hereby incorporated by reference in their entirety.

### TECHNICAL FIELD

This disclosure relates generally to virtual reality. More specifically, this disclosure relates to playing an earcon to direct a user to a region of interest within omnidirectional video content.

### BACKGROUND

Virtual reality experiences are becoming prominent. For example, 360° video is emerging as a new way of experiencing immersive video due to the ready availability of powerful handheld devices such as smartphones. 360° video enables immersive “real life,” “being there” experience for consumers by capturing the 360° view of the world. Users can interactively change their viewpoint and dynamically view any part of the captured scene they desire. Display and navigation sensors track head movement in real-time to determine the region of the 360° video that the user wants to view.

### SUMMARY

This disclosure provides uses of earcons for a region of interest identification in a 360-degree video.

In a first embodiment, an electronic device for indicating a region of interest within omnidirectional video content is provided. The electronic device includes a receiver. The receiver is configured to receive metadata for the region of interest in the omnidirectional video content. The metadata includes an earcon for the region of interest, timing information for the region of interest, and position information for the region of interest. The electronic device also includes a display. The display is configured to display a portion of the omnidirectional video content on a display. The electronic device also includes a speaker. The speaker is configured to play audio for the earcon to indicate the region of interest. The electronic device also includes a processor operably coupled to the receiver, the display, and the speaker. The processor is configured to determine whether to play the earcon to indicate the region of interest based on the timing and position information for the region of interest and the portion of the omnidirectional video content displayed on the display.

In another embodiment a method for indicating a region of interest within omnidirectional video content is provided. The method includes receiving metadata for the region of interest in the omnidirectional video content. The metadata includes an earcon for the region of interest, timing information for the region of interest, and position information for the region of interest. The method also includes displaying a portion of the omnidirectional video content on a display. The method further includes determining whether to play the earcon to indicate the region of interest based on the timing and position information for the region of interest and the portion of the omnidirectional video content displayed on the display. The method also includes playing audio for the earcon to indicate the region of interest.

In yet another embodiment a non-transitory computer readable medium embodying a computer program is provided. The computer program comprising program code that when executed causes at least one processor to receive metadata for the region of interest in the omnidirectional video content, the metadata including an earcon for the region of interest, timing information for the region of interest, and position information for the region of interest; display a portion of the omnidirectional video content on a display; determine whether to play the earcon to indicate the region of interest based on the timing and position information for the region of interest and the portion of the omnidirectional video content displayed on the display; and play audio for the earcon to indicate the region of interest.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example communication system in accordance with embodiments of the present disclosure;

FIG. 2 illustrates an example electronic device in accordance with an embodiment of this disclosure;

FIG. 3 illustrates an example block diagram in accordance with an embodiment of this disclosure;

FIG. 4 illustrates an example omnidirectional 360° virtual reality environment in accordance with an embodiment of this disclosure;

FIGS. 5A and 5B illustrate an example information transmission of the virtual reality content in accordance with an embodiment of this disclosure;

FIGS. 6A and 6B illustrate an example information transmission of an earcon in accordance with an embodiment of this disclosure; and

FIG. 7 illustrates an example method for providing an earcon to indicate a region of interest within omnidirectional video content in accordance with embodiments of the present disclosure.

### DETAILED DESCRIPTION

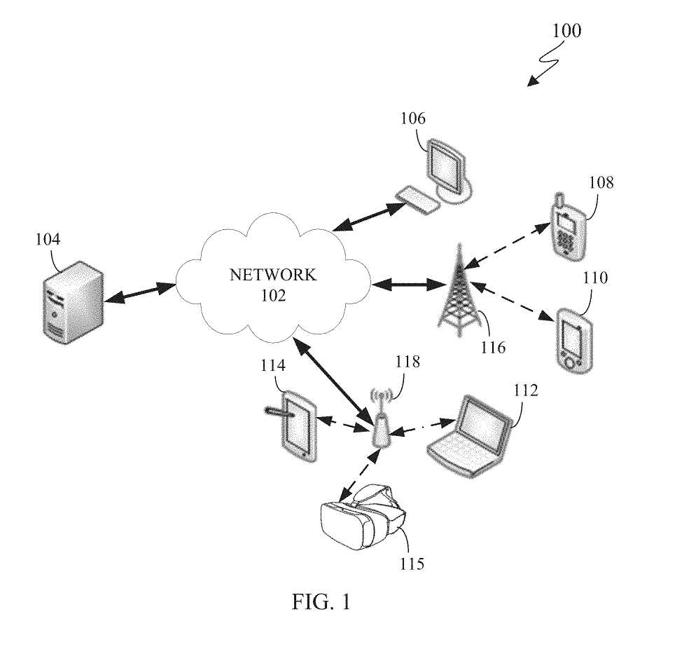

FIGS. 1 through 7, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably-arranged system or device.

Virtual reality (VR) is a rendered version of a visual and audio scene on a display or a headset. The rendering is designed to mimic the visual and audio sensory stimuli of the real world as naturally as possible to an observer or user as they move within the limits defined by the application. For example, VR places a user into immersive worlds that interact with their head movements. At the video level, VR is achieved by providing a video experience that covers as much of the field of view (FOV) of a user as possible together with the synchronization of the viewing angle of the rendered video with the head movements. Although multiple types of devices are able to provide such an experience, head-mounted displays (HMD) are the most popular. Typically HMDs rely on either (i) a dedicated screens integrated into the device and running with external computers, or (ii) a smartphone inserted into a headset via brackets. The first approach utilizes lightweight screens and benefits from a high computing capacity. In contrast the smartphone-based systems, utilizes a higher mobility and can be less expensive to produce. In both instances, the video experiences generated are similar.

VR content can be represented in different formats, such as panoramas or spheres, depending on the capabilities of the capture systems. For example, the content can be captured from real life or computer generated or a combination thereof. Events captured to video from the real world often require multiple (two or more) cameras to record the surrounding environment. While this kind of VR can be rigged by multiple individuals using numerous like cameras, two cameras per view are necessary to create depth. In another example, content can be generated by a computer such as computer generated images (CGI). In another example, combination of real world content with CGI is known as augmented reality (AR).

Once the VR content is captured or generated, regions of interest within the imagery can be defined in order to draw the attention of a user to a particular area within the omnidirectional 360° VR content. For example, if the author of the VR content identifies an object to highlight to a later viewer, the author can create a region of interest and notify the user to view the object. In certain embodiments, a melody or noise can be played, such as an earcon, to notify or guide or both the user of the region of interest. The earcon is an auditory notification that does not provide a visual distraction to the user that is viewing the VR content. An earcon represents a brief, distinctive sound used to convey information to a user. For example, an earcon is a short combination of tones that convey messages via audible tones, sounds, noises, and the like. Each different earcon can indicate different information for a human to device interaction. Various types of earcons can be utilized to indicate different types of regions of interest (ROI).

VR content is digital content that is viewable by a user in an omnidirectional 360° media scene (namely, a 360°×360° view). VR content also includes AR, mixed reality (MR), and other computer-augmented reality mediums that are presented to a user on a display. In certain embodiments, the display is a HMD. VR content places the viewer in an immersive environment that allows a user to interact and view different regions of the environment based on their head movements, as discussed above.

VR content can be represented in different formats, such as panoramas or spheres, depending on the capabilities of the capture systems. Many systems capture spherical videos covering the full 360°×180° view. A 360°×180° view is represented as a complete view of a half sphere. For example, a 360°×180° view is a view of a top half of a sphere where the viewer can view 360° in the horizontal plane and 180° vertical view plane. Capturing content within a 360°×180° view is typically performed by multiple cameras. Various camera configurations can be used for recording two-dimensional and three-dimensional content. The captured views from each camera are stitched together to combine the individual views of the omnidirectional camera systems to a single panorama or sphere. The stitching process typically avoids parallax errors and visible transitions between each of the single views.

When viewing omnidirectional VR content, the FOV of a user is limited to a portion of the of the omnidirectional VR content. That is, if a FOV of a user is 135° horizontally, and the omnidirectional VR content is 360° horizontally, then the user is only capable of viewing a portion of the omnidirectional VR content at a given moment. Often to indicate a particular region within the omnidirectional VR content an item is displayed and overlaid over the rendered content. For example, text and objects such as an arrow can be displayed to direct a user to a particular region within the omnidirectional VR content. Displaying text and objects is often distracting to the user as it blocks the content the user is currently viewing.

According to embodiments of the present disclosure, various methods for notifying and directing a user to a particular region within the omnidirectional VR content are provided. An earcon is played to direct a user to a particular region within the omnidirectional VR content without obscuring the content displayed on the display. For example, an earcon can include an audio tone or file that is utilized to notify or guide a user to a particular region within the omnidirectional VR content.

According to embodiments of the present disclosure, different earcons are utilized to direct a user to one or more ROI within an omnidirectional VR content. In certain embodiments, attributes of the earcon are modified to provide real time or near real time directions to a user. For example, the volume of the earcon can be increased or decreased as the FOV of the user approaches the ROI. Various types of attribute modifications can be used to indicate different directions a user is to look, or the distance the FOV of the user is from the ROI.

FIG. 1 illustrates an example computing system 100 according to this disclosure. The embodiment of the system 100 shown in FIG. 1 is for illustration only. Other embodiments of the system 100 can be used without departing from the scope of this disclosure.

The system 100 includes network 102 that facilitates communication between various components in the system 100. For example, network 102 can communicate Internet Protocol (IP) packets, frame relay frames, Asynchronous Transfer Mode (ATM) cells, or other information between network addresses. The network 102 includes one or more local area networks (LANs), metropolitan area networks (MANs), wide area networks (WANs), all or a portion of a global network such as the Internet, or any other communication system or systems at one or more locations.

The network 102 facilitates communications between a server 104 and various client devices 106-115. The client devices 106-115 may be, for example, a smartphone, a tablet computer, a laptop, a personal computer, a wearable device, or a head-mounted display (HMD). The server 104 can represent one or more servers. Each server 104 includes any suitable computing or processing device that can provide computing services for one or more client devices. Each server 104 could, for example, include one or more processing devices, one or more memories storing instructions and data, and one or more network interfaces facilitating communication over the network 102.

Each client device 106-115 represents any suitable computing or processing device that interacts with at least one server or other computing device(s) over the network 102. In this example, the client devices 106-115 include a desktop computer 106, a mobile telephone or mobile device 108 (such as a smartphone), a personal digital assistant (PDA) 110, a laptop computer 112, a tablet computer 114, and a HMD 115. However, any other or additional client devices could be used in the system 100. HMD 115 can be a standalone device with an integrated display and processing capabilities, or a headset that includes a bracket system that can hold another client device such as mobile device 108. As described in more detail below the HMD 115 can display VR content to one or more users, and speakers to broadcast audible earcons.

In this example, some client devices 108-115 communicate indirectly with the network 102. For example, the client devices 108 and 110 (mobile devices 108 and PDA 110, respectively) communicate via one or more base stations 116, such as cellular base stations or eNodeBs (eNBs). Also, the client devices 112, 114, and 115 (laptop computer 112, tablet computer 114, and HMD 115, respectively) communicate via one or more wireless access points 118, such as IEEE 802.11 wireless access points. Note that these are for illustration only and that each client device 106-115 could communicate directly with the network 102 or indirectly with the network 102 via any suitable intermediate device(s) or network(s).

In certain embodiments, the HMD 115 (or any other client device 106-114) transmits information securely and efficiently to another device, such as, for example, the server 104. The mobile device 108 (or any other client device 106-115) can function as a VR display when attached to a headset and can function similar to HMD 115. The HMD 115 (or any other client device 106-114) can trigger the information transmission between itself and server 104.

Although FIG. 1 illustrates one example of a system 100, various changes can be made to FIG. 1. For example, the system 100 could include any number of each component in any suitable arrangement. In general, computing and communication systems come in a wide variety of configurations, and FIG. 1 does not limit the scope of this disclosure to any particular configuration. While FIG. 1 illustrates one operational environment in which various features disclosed in this patent document can be used, these features could be used in any other suitable system.

The processes and systems provided in this disclosure allow for an earcon to be broadcasted over one or more speakers to direct a user to a ROI. For example, when two or more speakers as affixed to a HMD, each speaker can receive a different audio channel to guide the user to the center of the ROI. In certain embodiments, the ROI is within the omnidirectional video content but not in the FOV of the user. In certain embodiments, client devices 106-115 display VR content while the client devices 106-115 or the server 104 select an earcon to play to indicate a ROI during the playback of VR content.

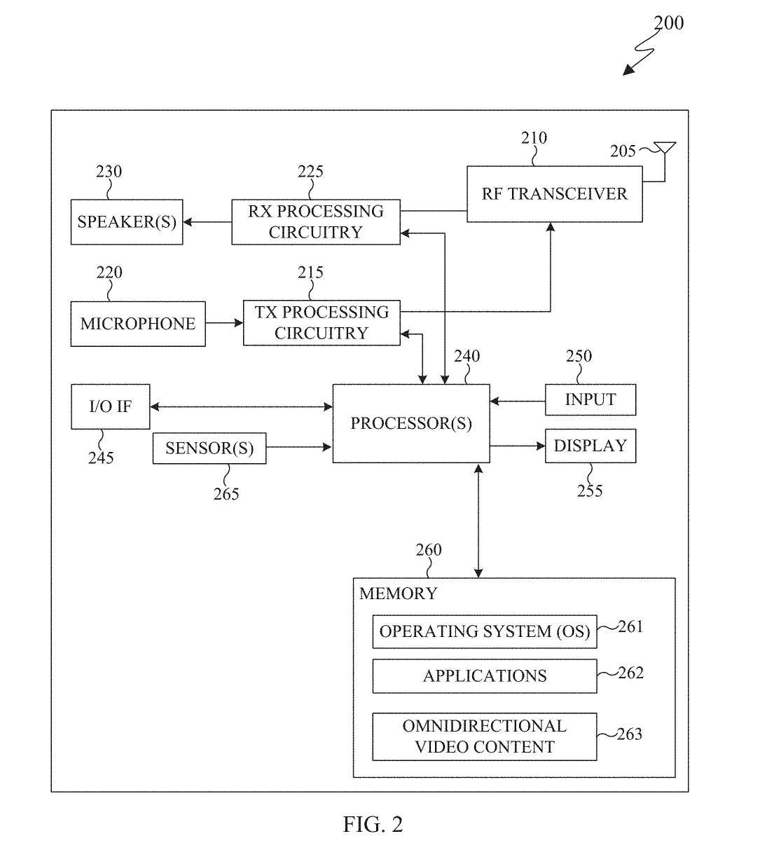

FIG. 2 illustrates an electronic device, in accordance with an embodiment of this disclosure. The embodiment of the electronic device 200 shown in FIG. 2 is for illustration only and other embodiments can be used without departing from the scope of this disclosure. The electronic device 200 can come in a wide variety of configurations, and FIG. 2 does not limit the scope of this disclosure to any particular implementation of an electronic device. In certain embodiments, one or more of the client devices 104-115 of FIG. 1 can include the same or similar configuration as electronic device 200.

In certain embodiments, the electronic device 200 is a HMD used to display VR content to a user. In certain embodiments, the electronic device 200 is a computer (similar to the desktop computer 106 of FIG. 1), mobile device (similar to mobile device 108 of FIG. 1), a PDA (similar to the PDA 110 of FIG. 1), a laptop (similar to laptop computer 112 of FIG. 1), a tablet (similar to the tablet computer 114 of FIG. 1), a HMD (similar to the HMD 115 of FIG. 1), and the like. In certain embodiments, electronic device 200 determines whether a ROI is currently displayed on a HMD. In certain embodiments, electronic device 200 determines whether to play the earcon to indicate the ROI based on the timing and position information for the ROI or the portion of the omnidirectional video content displayed on the display, or both.

As shown in FIG. 2, the electronic device 200 includes an antenna 205, a radio frequency (RF) transceiver 210, transmit (TX) processing circuitry 215, a microphone 220, and receive (RX) processing circuitry 225. In certain embodiments, the RF transceiver 210 is a general communication interface and can include, for example, a RF transceiver, a BLUETOOTH transceiver, or a WI-FI transceiver ZIGBEE, infrared, and the like. The electronic device 200 also includes a speaker(s) 230, processor(s) 240, an input/output (I/O) interface (IF) 245, an input 250, a display 255, a memory 260, and sensor(s) 265. The memory 260 includes an operating system (OS) 261, one or more applications 262, and omnidirectional video content 263. The memory 260 can include voice recognition dictionary containing learned words and commands.

The RF transceiver 210 receives, from the antenna 205, an incoming RF signal such as a BLUETOOTH or WI-FI signal from an access point (such as a base station, WI-FI router, BLUETOOTH device) of a network (such as Wi-Fi, BLUETOOTH, cellular, 5G, LTE, LTE-A, WiMAX, or any other type of wireless network). The RF transceiver 210 down-converts the incoming RF signal to generate an intermediate frequency or baseband signal. The intermediate frequency or baseband signal is sent to the RX processing circuitry 225 that generates a processed baseband signal by filtering, decoding, or digitizing, or a combination thereof, the baseband or intermediate frequency signal. The RX processing circuitry 225 transmits the processed baseband signal to the speaker(s) 230, such as for voice data, or to the processor 240 for further processing, such as for web browsing data or image processing, or both. In certain embodiments speaker(s) 230 includes one or more speakers.

The TX processing circuitry 215 receives analog or digital voice data from the microphone 220 or other outgoing baseband data from the processor 240. The outgoing baseband data can include web data, e-mail, or interactive video game data. The TX processing circuitry 215 encodes, multiplexes, digitizes, or a combination thereof, the outgoing baseband data to generate a processed baseband or intermediate frequency signal. The RF transceiver 210 receives the outgoing processed baseband or intermediate frequency signal from the TX processing circuitry 215 and up-converts the baseband or intermediate frequency signal to an RF signal that is transmitted via the antenna 205.

The processor 240 can include one or more processors or other processing devices and execute the OS 261 stored in the memory 260 in order to control the overall operation of the electronic device 200. For example, the processor 240 can control the reception of forward channel signals and the transmission of reverse channel signals by the RF transceiver 210, the RX processing circuitry 225, and the TX processing circuitry 215 in accordance with well-known principles. The processor 240 is also capable of executing other applications 262 resident in the memory 260, such as, one or more applications for identifying a ROI or selecting an appropriate earcon to direct the user to the ROI, or both. The processor 240 can include any suitable number(s) and type(s) of processors or other devices in any suitable arrangement. For example, the processor 240 is capable of natural langue processing, voice recognition processing, object recognition processing, eye tracking processing, and the like. In some embodiments, the processor 240 includes at least one microprocessor or microcontroller. Example types of processor 240 include microprocessors, microcontrollers, digital signal processors, field programmable gate arrays, application specific integrated circuits, and discreet circuitry.

The processor 240 is also capable of executing other processes and programs resident in the memory 260, such as operations that receive, store, and timely instruct by providing voice and image capturing and processing. The processor 240 can move data into or out of the memory 260 as required by an executing process. In some embodiments, the processor 240 is configured to execute a plurality of applications 262 based on the OS 261 or in response to signals received from eNBs or an operator.

The processor 240 is also coupled to the I/O interface 245 that provides the electronic device 200 with the ability to connect to other devices such as the client devices 106-115. The I/O interface 245 is the communication path between these accessories and the processor 240

The processor 240 is also coupled to the input 250 and the display 255. The operator of the electronic device 200 can use the input 250 to enter data or inputs, or a combination thereof, into the electronic device 200. Input 250 can be a keyboard, touch screen, mouse, track ball or other device capable of acting as a user interface to allow a user in interact with electronic device 200. For example, the input 250 can include a touch panel, a (digital) pen sensor, a key, an ultrasonic input device, or an inertial motion sensor. The touch panel can recognize, for example, a touch input in at least one scheme along with a capacitive scheme, a pressure sensitive scheme, an infrared scheme, or an ultrasonic scheme. In the capacitive scheme, the input 250 is able to recognize a touch or proximity. Input 250 can be associated with sensor(s) 265, a camera, or a microphone, such as or similar to microphone 220, by providing additional input to processor 240. In certain embodiments, sensor 265 includes inertial sensors (such as, accelerometers, gyroscope, and magnetometer), optical sensors, motion sensors, cameras, pressure sensors, heart rate sensors, altimeter, and the like. The input 250 also can include a control circuit.

The display 255 can be a liquid crystal display, light-emitting diode (LED) display, organic LED (OLED), active matrix OLED (AMOLED), or other display capable of rendering text and graphics, such as from websites, videos, games and images, and the like. Display 255 can be sized to fit within a HMD. Display 255 can be a singular display screen or multiple display screens for stereoscopic display. In certain embodiments, display 255 is a heads up display (HUD).

The memory 260 is coupled to the processor 240. Part of the memory 260 can include a random access memory (RAM), and another part of the memory 260 can include a Flash memory or other read-only memory (ROM).

The memory 260 can include persistent storage (not shown) that represents any structure(s) capable of storing and facilitating retrieval of information (such as data, program code, or other suitable information on a temporary or permanent basis). The memory 260 can contain one or more components or devices supporting longer-term storage of data, such as a ready only memory, hard drive, flash memory, or optical disc. The memory 260 also can contain omnidirectional video content 263. Omnidirectional video content 263 includes 360° video and metadata indicating one or more ROI within the video content. In certain embodiments, the metadata also indicates a specific earcon that is associated with the ROI. In certain embodiments, the metadata also includes timing information for the ROI within the video content. In certain embodiments, the metadata also includes position information for the ROI within the 360° video.

Electronic device 200 further includes one or more sensor(s) 265 that are able to meter a physical quantity or detect an activation state of the electronic device 200 and convert metered or detected information into an electrical signal. In certain embodiments, sensor 265 includes inertial sensors (such as accelerometers, gyroscopes, and magnetometers), optical sensors, motion sensors, cameras, pressure sensors, heart rate sensors, altimeter, breath sensors (such as microphone 220), and the like. For example, sensor(s) 265 can include one or more buttons for touch input (such as on the headset or the electronic device 200), a camera, a gesture sensor, a gyroscope or gyro sensor, an air pressure sensor, a magnetic sensor or magnetometer, an acceleration sensor or accelerometer, a grip sensor, a proximity sensor, a color sensor, a bio-physical sensor, a temperature/humidity sensor, an illumination sensor, an Ultraviolet (UV) sensor, an Electromyography (EMG) sensor, an Electroencephalogram (EEG) sensor, an Electrocardiogram (ECG) sensor, an Infrared (IR) sensor, an ultrasound sensor, an iris sensor, a fingerprint sensor, and the like. The sensor(s) 265 can further include a control circuit for controlling at least one of the sensors included therein. The sensor(s) 265 can be used to determine an orientation and facing direction, as well as geographic location of the electronic device 200. Any of these sensor(s) 265 can be disposed within the electronic device 200, within a headset configured to hold the electronic device 200, or in both the headset and electronic device 200, such as in embodiments where the electronic device 200 includes a headset.

Although FIG. 2 illustrates one example of electronic device 200, various changes can be made to FIG. 2. For example, various components in FIG. 2 can be combined, further subdivided, or omitted and additional components can be added according to particular needs. As a particular example, the processor 240 can be divided into multiple processors, such as one or more central processing units (CPUs), one or more graphics processing units (GPUs), one or more an eye tracking processors, and the like. Also, while FIG. 2 illustrates the electronic device 200 configured as a mobile telephone, tablet, smartphone, or HMD, the electronic device 200 can be configured to operate as other types of mobile or stationary devices.

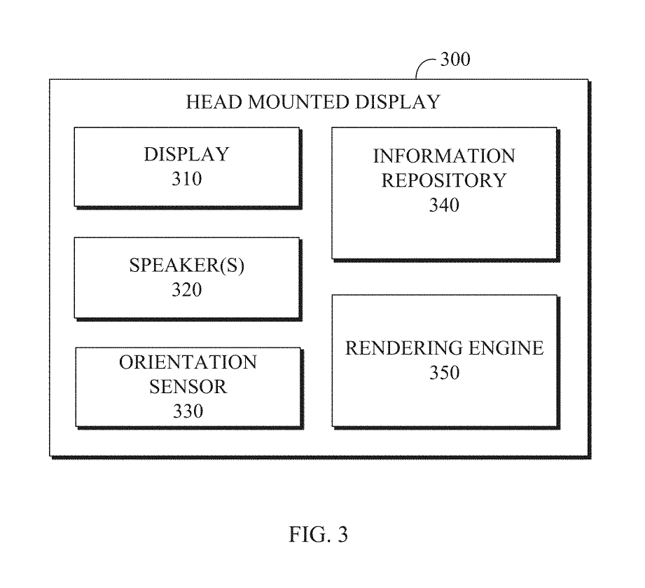

FIG. 3 illustrates a block diagram of head mounted display (HMD) 300, in accordance with an embodiment of this disclosure. The embodiment of the HMD 300 shown in FIG. 3 is for illustration only. Other embodiments can be used without departing from the scope of the present disclosure.

HMD 300 illustrates a high-level architecture, in accordance with an embodiment of this disclosure. HMD 300 renders VR content such as a pre-recorded omnidirectional 360° video. HMD 300 can direct a user to a ROI within the VR content by playing an audio associated with an earcon. When the audio of the earcon is played over one or more speakers, the earcon attracts the user to the ROI

HMD 300 can be configured similar to any of the one or more client devices 106-115 of FIG. 1, and can include internal components similar to that of electronic device 200 of FIG. 2. For example, HMD 300 can be similar to the HMD 115 of FIG. 1, as well as a desktop computer (similar to the desktop computer 106 of FIG. 1), a mobile device (similar to the mobile device 108 and the PDA 110 of FIG. 1), a laptop computer (similar to the laptop computer 112 of FIG. 1), a tablet computer (similar to the tablet computer 114 of FIG. 1), and the like.

In certain embodiments, the HMD 300 is worn on the head of a user as part of a helmet, similar to HMD 115 of FIG. 1. HMD 300 can display VR, AR, or MR, or a combination thereof. HMD 300 includes a display 310, a speaker(s) 320, an orientation sensor 330, an information repository 340, and a rendering engine 350.

HMD 300 is an electronic device that can display content, such as text, images, and video through a GUI, such as display 310. Display 310 is similar to display 255 of FIG. 2. In certain embodiments, display 310 is a standalone display affixed to HMD 300 via brackets. For example, display 310 is similar to a display screen on mobile device, or a display screen on a computer or tablet. In certain embodiments, display 310 includes two displays, for a stereoscopic display providing a single display for each eye of a user. In certain embodiments, HMD 300 can completely replace the FOV of a user with the display 310 depicting a simulated visual component. The display 310 can render, display or project VR, AR, and the like.

Speaker(s) 320 are similar to speaker(s) 230 of FIG. 2. Speaker(s) 320 receive an electrical signal and convert the electrical signal into sound waves. In certain embodiments speaker(s) 320 are one or more speakers and each speaker can receive a different electrical signal. For example, when speaker(s) 320 includes two speakers within the HMD 300, each of the two speakers can receive different electrical signals to create multidirectional audible perspective in order to create the impression of sound from various directions, using two independent audio channels. The impression of sound from various directions can guide and direct a user to the center of an ROI. The audible sound produced by the speaker(s) 320 can include audio from the VR content and an earcon. In certain embodiments, the speaker(s) 320 are audio speakers located in a headphone or headset.

Orientation sensor 330 senses the motion of the HMD 300 caused by head movements of the user. Orientation sensor 330 provides for head and motion tracking of the user based on the position of the user's head. By tracking the motion of the user's head, orientation sensor 330 allows the rendering engine 350 to simulate visual and audio components in order to ensure that, from the user's perspective, items and sound sources remain consistent with the user's movements. The orientation sensor 330 can include various sensors such as an inertial sensor, an acceleration sensor, a gyroscope gyro sensor, magnetometer, and the like. For example, the orientation sensor 330, detects magnitude and direction of movement of a user with respect to the display 310. By detecting the movements of the user with respect to the display, the viewpoint displayed on the display 310 to the user is dynamically changed. That is, the orientation sensor 330 allows a user to interactively change a viewpoint and dynamically view any part of the captured scene, by sensing movement of the user.

Information repository 340 can be similar to memory 260 of FIG. 2. In certain embodiments, information repository 340 is similar to omnidirectional video content 263 of FIG. 2. Information repository 340 can store one or more 360° videos, metadata associated with the 360° video(s), or an earcon, or a combination thereof. Data stored in information repository 340 includes various audio recordings of an earcon, 360° video, and the like. In certain embodiments, information repository 340 maintains a log of the ROIs within a 360° video, in order to play an earcon prior to rendering the ROI on or off the display 310. Information repository 340 can maintain timing information for the ROI, to identify when the ROI is rendered on or off the display 310. Information repository 340 can also maintain position information for the region of interest within the 360° video.

Rendering engine 350 renders the VR content, and detects whether the video includes any ROI. In certain embodiments, rendering engine 350 detects and plays an earcon associated with the ROI within the 360° video of the VR content, and a VR renderer renders the VR content of the omnidirectional 360° video. For example, rendering engine 350 can detect a ROI through metadata associated with the 360° VR content. The metadata can indicate a particular earcon or audio associated with an earcon to play to indicate the ROI to a user viewing the VR content on the HMD 300. Different earcons are associated with different ROIs. Rendering engine 350 selects and plays an earcon to direct a user to the particular ROI as indicated in the metadata.

In certain embodiments, the metadata can include a particular earcon for a ROI. In certain embodiments, the metadata can include timing information for the ROI, such as when the ROI when the ROI is able to be rendered on the display 310. For example, if the 360° VR content is a prerecorded video, the ROI is only able to be rendered at certain time intervals during the playback of the video. Therefore, the metadata can include timing information indicating instances when the ROI is able to be viewed on the display 310, dependent on the viewing direction of the user within the 360° VR content. In certain embodiments, the metadata can also include position information within the VR content. For example, the positional information provides a location of the ROI within a particular area of the omnidirectional 360° VR content.

Rendering engine 350 determines whether to play an earcon via speaker(s) 320 in order to indicate a ROI to a user. In certain embodiments, the rendering engine 350 determines whether the play an earcon based on (i) the timing of the ROI, (ii) the position information of the ROI within the omnidirectional 360° video, (iii) a portion of the VR content displayed on the display 310, or a combination thereof. For example, rendering engine 350 determines whether the play audio of an earcon (e.g., from an audio file) based on a timestamp associated with the ROI. The timestamp can indicate when the ROI can be rendered on the display 310. That is, the VR content can be a prerecorded video that follows a predefined sequence, where the ROI is able to be rendered at certain instances during the playback of the VR content. In another example, the position information of the ROI within the omnidirectional 360° video is based on the azimuth and an elevation location within the VR content. In another example, the position information of the ROI within the omnidirectional 360° video is based on the yaw and pitch located within the VR content. The position information indicates where in the 360° imagery that the ROI is located. There are portions of the 360° video that are not rendered on the display 310 as the display 310 displays only a portion of the VR content at a given instant. The position information of the ROI, coupled with the portion of the omnidirectional video content displayed on the display 310 whether the ROI is on or off the display 310. In certain embodiments, rendering engine 350 plays an earcon via two or more speakers via speaker(s) 230. For example, the rendering engine 350 can provide each speaker with an independent audio channel to direct a user to specific points in the omnidirectional 360° video, such as the center of an ROI.

In certain embodiments, rendering engine 350 determines not to play an earcon when the ROI is already displayed on the display 310. For example, when the ROI is already displayed on the display 310, there is no reason to attract the user to the ROI, as the ROI is already visible to the user. In certain embodiments, rendering engine 350 determines to play an earcon regardless of whether the ROI is displayed or not displayed on the display 310.

In certain embodiments, rendering engine 350 determines to play the earcon at a time interval prior to the ROI being rendered on or off the display 310. For example, rendering engine 350 determines to play an earcon, and direct a user to a location within the 360° VR content prior to the ROI being rendered in order for the user to view the ROI when the ROI is rendered on the display 310.

Rendering engine 350 can modify attributes of the audio to indicate different features of the ROI. For example, attributes of the audio can include gain and the frequency. Gain is the decibel level or loudness of the audio, whereas frequency identifies the pitch of the sound. A typical human can hear frequencies ranging from 20 to 20,000 Hz. In certain embodiments, the rendering engine 350 can increase or decrease attributes of the audio as the FOV of the user moves towards or away from the ROI. For example, as the FOV of the user moves closer to the ROI, the gain of the earcon can increase. In another example, as the FOV of the user moves closer to the ROI, the frequency of the earcon can increase. Similarly, the gain and frequency can decrease as the user moves closer to the ROI. In certain embodiments, the rendering engine 350 can gradually increase or decrease the attributes of the audio as the FOV of the user moves towards or away from the ROI.

Rendering engine 350 modifies the earcon to direct the user to the ROI, regardless of whether the attribute is increased or decreased. In certain embodiments, when the earcon is initially played, the initial loudness or gain of the earcon is set to a predetermined percentage of the gain of the audio of the VR content. For example, the gain of the earcon is set at half the gain of the audio in the VR content. In order to guide the user to the correct viewing direction, the gain of the earcon decreases while the user is turning towards the ROI, and increases while the user is turning away from the ROI. A direction-dependent gain can be applied to the earcon. Rendering engine 350 can modify the gain attribute, by decreasing the gain (such as the loudness) of the earcon as the user is turning towards the ROI, based on the following equation:

$$g = \{ \begin{matrix}0 & if \vert θ - {θ}_{r} \vert < ϵ and \vert ϕ - {ϕ}_{r} \vert < ϵ \\ 1 + \frac{\vert θ - {θ}_{r} \vert}{360} + \frac{\vert θ - {θ}_{r} \vert}{180} , & otherwise\end{matrix} \qquad Equation 1$$

Referring to Equation 1, θ and φ are the azimuth and elevation of the viewing direction of the user. Additionally, θ and φ are measured in degrees. θᵣ and φᵣ are the azimuth and elevation of the center of the ROI, measured in degrees. ϵ denotes a threshold that changes based on the accuracy of the orientation sensor 330. It is noted that azimuth and elevation can be the yaw and pitch respectively. When rendering engine 350 applies Equation 1 to an earcon, the gain of the earcon is the highest or loudest and equal to the gain of the audio in the VR content when the user viewing exactly 180° from the ROI. The gain of the earcon gradually decreases the closer the viewing direction of the user is to the ROI.

Similarly, rendering engine 350 can modify the attribute corresponding to gain by increasing the gain of the earcon as the user is turning towards the ROI, based on the following equation:

$$g = \{ \begin{matrix}2 & if \vert θ - {θ}_{r} \vert < ϵ and \vert ϕ - {ϕ}_{r} \vert < ϵ \\ 2 - \frac{\vert θ - {θ}_{r} \vert}{360} - \frac{\vert θ - {θ}_{r} \vert}{180} , & otherwise\end{matrix} \qquad Equation 2$$

Referring to Equation 2, θ and φ are the azimuth and elevation of the viewing direction of the user, and measured in degrees. θᵣ and φᵣ are the azimuth and elevation of the center of the ROI, measured in degrees. ϵ denotes a threshold that changes based on the accuracy of the orientation sensor 330. It is noted that azimuth and elevation can be the yaw and pitch respectively. When rendering engine 350 applies Equation 2 to an earcon, the gain of the earcon is at a minimum when the user viewing exactly 180° from the ROI, and at a maximum when the user is viewing the ROI.

In another example, rendering engine 350 can modify the frequency attribute by decreasing the frequency of the audio (such as the pitch) while the user is turning towards the ROI, based on the following equation:

$$f = \{ \begin{matrix}0 & if \vert θ - {θ}_{r} \vert < ϵ and \vert ϕ - {ϕ}_{r} \vert < ϵ \\ ( \frac{\vert θ - {θ}_{r} \vert}{360} + \frac{\vert θ - {θ}_{r} \vert}{180} ) {f}_{0} , & otherwise\end{matrix} \qquad Equation 3$$

Referring to Equation 3, θ and φ are the azimuth and elevation of the viewing direction of the user, and measured in degrees. θᵣ and φᵣ are the azimuth and elevation of the center of the ROI, measured in degrees. ϵ denotes a threshold that changes based on the accuracy of the orientation sensor 330. f₀ denotes the maximum frequency of the earcon. The maximum frequency of the earcon occurs when the user looks at the opposite direction of the earcon. It is noted that azimuth and elevation can be the yaw and pitch respectively.

In another example, rendering engine 350 can modify the frequency attribute by decreasing the frequency of the audio (such as the pitch) while the user is turning towards the ROI, based on the following equation:

$$f = \{ \begin{matrix}2 {f}_{0} & if \vert θ - {θ}_{r} \vert < ϵ and \vert ϕ - {ϕ}_{r} \vert < ϵ \\ ( 2 - \frac{\vert θ - {θ}_{r} \vert}{360} - \frac{\vert θ - {θ}_{r} \vert}{180} ) {f}_{0} , & otherwise\end{matrix} \qquad Equation 4$$

Referring to Equation 4, θ and φ are the azimuth and elevation of the viewing direction of the user, and measured in degrees. θᵣ and φᵣ are the azimuth and elevation of the center of the ROI, measured in degrees. ϵ denotes a threshold that changes based on the accuracy of the orientation sensor 330. f₀ denotes the maximum frequency of the earcon. The maximum frequency of the earcon occurs when the user looks at the earcon. It is noted that azimuth and elevation can be the yaw and pitch respectively.

In another example, rendering engine 350 can modify both the frequency and the gain of the earcon. That is, both the gain of the frequency of the earcon can be changed, by increasing or decreasing both attributes, to guide the user to the ROI. The gain is the loudness of the audio while frequency is the pitch of the audio.

In certain embodiments, rendering engine 350 can play different audio for the earcon to indicate different types of ROI. That is, a set of earcons are associated with different types of activities in the ROI. By changing the sound of the earcon, notifies a user of the type of ROI and allow the user to determine whether the find the ROI. Example types of ROI can include sports, music, dialog, attractive scenery, and the like. The audio of each earcon can provide information to a user allowing the user to identify the type of ROI. Each earcon is distinguishable, in order to allow the user to identify the type of ROI. For example, different musical instruments can be played where each instrument indicates a type of ROI. Musical instruments can include a piano, a violin, a trumpet, drums, and the like. Since certain musical instruments sound very different, such as a piano and a trumpet, a user can easily associate an earcon of a trumpet to one type of ROI while a piano indicates another type of ROI. For example, if the ROI type is sports, the earcon can be audio can be a trumpet playing a melody, while an earcon of a piano playing a melody indicates a ROI of scenery. Altering the earcon based on the type of ROI allows a user to search for the ROI or disregard the earcon and the ROI if it is a type that does not interest the user. In certain embodiments, the gain of the earcon is set to the gain of the audio in the VR content. For example, the gain of the earcon matches the gain of the audio in the VR content. In certain embodiments, the attributes of the earcon can be modified by any of the Equations 1-4 to guide the user to the ROI.

In certain embodiments, the metadata associated with the omnidirectional 360° video includes a recommended level for the ROI. Each ROI can include a recommendation level that indicates on how important each ROI is. For example, if the ROI recommendation level is low, then rendering engine 350 plays two low pitch notes via speaker(s) 320, and if the ROI recommendation level is high, then rendering engine 350 plays two high pitch notes via speaker(s) 320. By altering the pitch of the earcons, indicates to a user the respective recommendation level of the ROI. It is noted that the gain of the earcon can be altered based on the recommendation level of the earcon. In certain embodiments, the attributes of the earcon can be modified by any of the Equations 1-4 to guide the user to the ROI. In certain embodiments, the recommendation level can be predefined or derived based on previous ROIs the user has viewed or interests of the user or both. For example, the recommendation level is predefined when the author of the VR content determines the recommendation level of each ROI. In another example, the level is predefined by the number of views each ROI of the VR content receives as indicated by received social media information. In another example, the rendering engine 350 recommends an ROI based on the previous ROI of the user. For instance, rendering engine 350 can monitor the ROI's most viewed by the user and detect a pattern of similar ROIs, in order to recommend future ROI to the user.

In certain embodiments, multiple ROIs can be present simultaneously or near-simultaneously. For example, each ROI can have a unique earcon indicating information about the ROI, such as the type of ROI or the recommendation level of the ROI. Rendering engine 350 plays each earcon to notify the user of each ROI. The orientation sensor 330 detects movement such as the user's FOV moving towards a first ROI and away from a second ROI. When the FOV of the user is moving towards the first ROI and away from the second ROI, the earcon associated with the first earcon can change according to any of the Equations 1-4, and the earcon associated with the second ROI, stops playing. That is, as the user moves towards the ROI, the rendering engine 350 can gradually increase or decrease the gain or frequency of the first earcon to guide the user to the ROI.

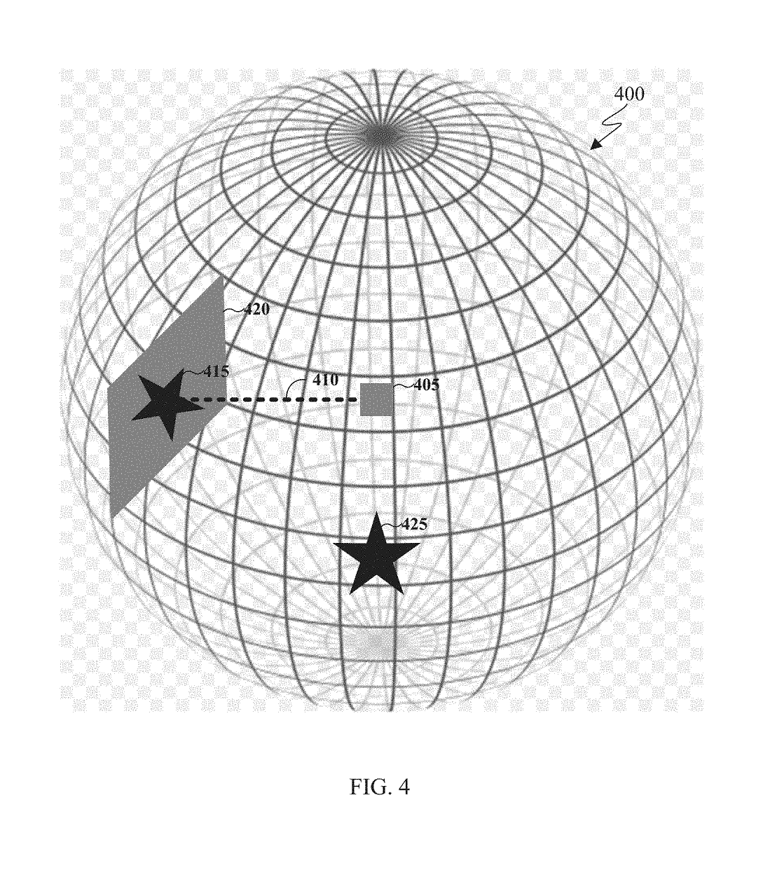

FIG. 4 illustrates an example omnidirectional 360° virtual reality environment in accordance with an embodiment of this disclosure. FIG. 4 illustrates an environment depicting a sphere 400. Sphere 400 illustrates an omnidirectional 360° video with the user viewing from location 405. The VR scene geometry is created as a sphere and placing the rendering camera in the center of the sphere at location 405, and rendering the 360° video content around the location. Location 405 is the viewpoint of the user within the 360° video content. For example, the user can look up, down, left and right in 360° and view content in any direction from location 405. The FOV of the user is limited to the viewing direction within the sphere 400 as viewed from location 405. For example, when a user at location 405 is viewing along a viewing direction 410 at object 415, the field of view of the user is limited to FOV 420. FOV 420 represents content that is displayed to a user on a display similar to display 310 of FIG. 3. When the viewing direction 410 of a user changes, the FOV 420 moves throughout the omnidirectional 360° video of the sphere 400. If object 425 if a ROI located within the omnidirectional 360° video the object 425 is not rendered as it is not within the FOV 420 of the user. If the user's viewing direction 410 is shifted to the object 425, then the object 425 is rendered while the object 415 is not rendered on the display for the user to view. That is, if the user is viewing object 415, the user cannot view object 425, as the objects are not within the FOV 420 of the user.

During the playback of the VR content, object 425 can be rendered on FOV 420 during one or more times in predefined locations within the omnidirectional 360° video. Based on the sequential events of the VR content, timing and position information for the object 425 indicates when and where the object 425 is located. In certain embodiments, object 425 is a ROI. When the timing and position information for the object 425 indicates that object 425 can be rendered at a location the user is not currently viewing, a rendering engine, such as rendering engine 350 of FIG. 3, plays an earcon associated with the ROI to notify the user of object 425. The rendering engine can guide the user to the object 425 by modifying the earcon. The rendering engine can modify the earcon based on any of the Equations 1-4. For example, the an attribute (gain, frequency or both) can be increased or decreased as the FOV 420 moves towards object 425.

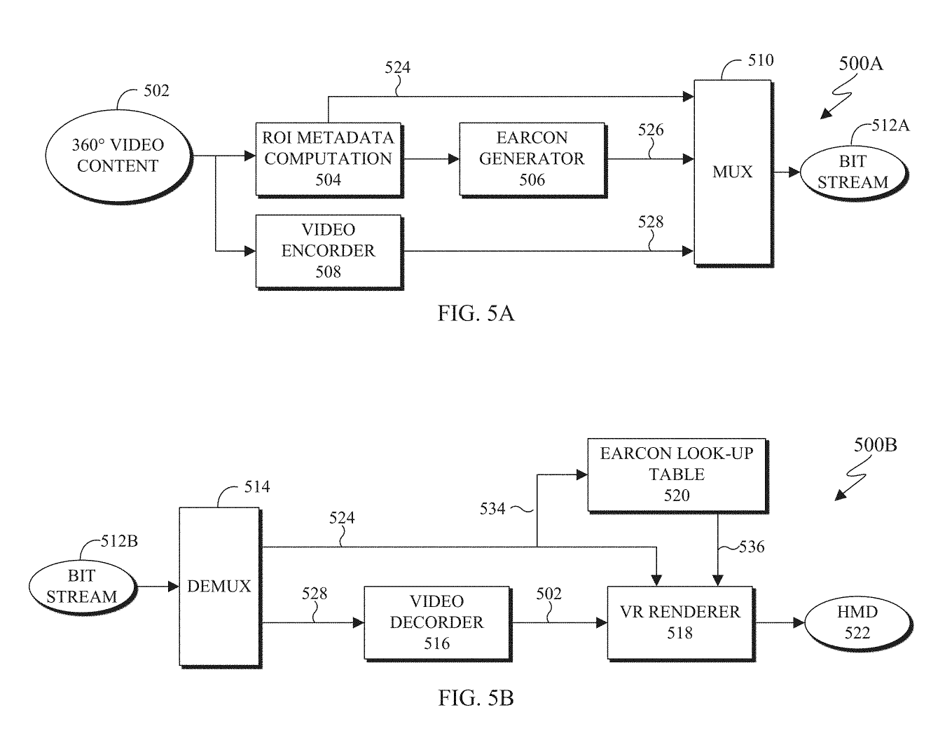

FIGS. 5A and 5B illustrate an example information transmission of the virtual reality content in accordance with an embodiment of this disclosure. FIG. 5A illustrates a transmitter of an earcon in accordance with an embodiment of this disclosure. FIG. B illustrates a receiver of an earcon in accordance with an embodiment of this disclosure. Other embodiments can be used without departing from the scope of the present disclosure.

FIG. 5A illustrates environment 500A of an example transmitter transmitting information of 360° video content 502. Environment 500A illustrates an example process of generating a specific earcon and transmitting the specific earcon as metadata for each ROI. The environment 500A can be located in a server similar to server 104 of FIG. 1.

The environment 500A receives the 360° video content 502. The 360° video content 502 is sent to the ROI metadata computation engine 504 and the video encoder 508. The ROI metadata computation engine 504 generates the ROI metadata that specifies various information about each earcon that is associated with each ROI. In certain embodiments, the metadata generated by the ROI metadata computation engine 504 includes (i) an earcon for the ROI, (ii) the timing information for the ROI, (iii) position information for the ROI, or a combination thereof. ROI metadata computation engine 504 outputs ROI metadata 524 and transmits the ROI metadata 524 to the multiplexer 510. The ROI metadata computation engine 504 also information associated with the generated ROI metadata and the 360° video content 502 to the earcon generator 506. The earcon generator 506 generates the audio for the earcon. The earcon generator 506 generates the audio for each ROI. The earcon generator 506 outputs the earcon 526 to the multiplexer 510. Additionally, the 360-degree content 502 is also transmitted to the video encoder 508. The video encoder 508 encodes the 360° content in order to transmit the data to a receiver. The video encoder 508 outputs the encoded 360° video content 528 to the multiplexer 510. The multiplexer 510 receives input from three sources: the ROI metadata 524, the earcon 526, and the encoded 360° video content 528. The multiplexer 510 combines the three inputs and creates a single output, such as bit stream 512A.

FIG. 5B illustrates environment 500B of an example receiver receiving a bit stream 512B. In certain embodiments, bit stream 512A and 512B are the same information, where bit stream 512A is transmitted and bit stream 512B is received at a HMD 522, similar to HMD 300 of FIG. 3. Environment 500B illustrates an example process of rendering a specific earcon and for each specific ROI.

The environment 500B receives the bit stream 512B. In certain embodiments, the bit stream 512B includes metadata for each earcon that is transmitted along with the 360° video content. The demultiplexer 514 is a device takes the single input line of bit stream 512B and routes it to one of several output lines. Specifically, the demultiplexer 514 receives the bit stream 512B and extracts ROI metadata 524 and the encoded 360° video content 528. A video decoder 516 receives the encoded 360° video content 528. The video decoder decodes the encoded 360° video content 528.

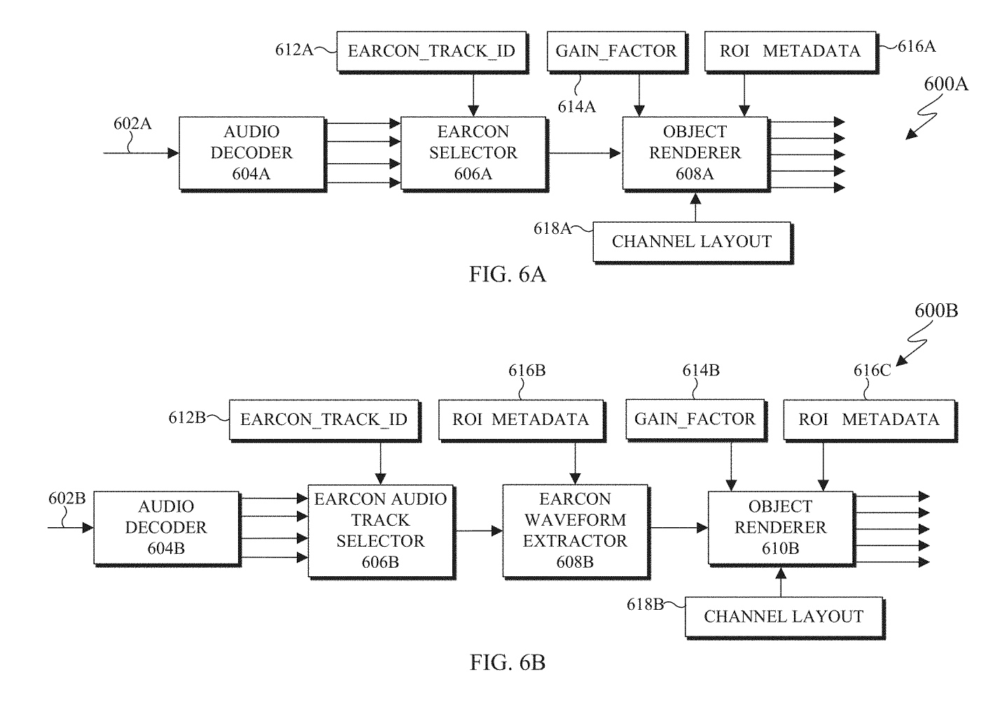

The ROI metadata 524 includes earcon identification 534. The earcon metadata indicates the earcon information related to the ROI. Based on the earcon identification 534, the earcon look-up table 520 selects a specific earcon 536 that is associated with a specific ROI. The earcon identification 534 identifies each earcon that is associated each specific ROI in the earcon look-up table 520. In certain embodiments, the earcon look-up table 520 is an information repository (similar to information repository 340 of FIG. 3) that stores the earcons. In certain embodiments, environment 500A and environment 500B have the same look up table. In certain embodiments, an information repository that includes the earcons is transmitted to the receiver as a preamble. For example, for an ROI, the corresponding earcon identification is transmitted in the bit stream 512A and 512B. In certain embodiments, the earcon look-up table 520 includes one or more tracks of audio for one or more earcons. For example, multiple earcons can be located in a single audio track. In another example, each earcon can have its own audio track. Example syntax for the various embodiments of the earcon look-up table 520 are described with reference to FIGS. 6A and 6B, below.

The VR renderer 518 receives the 360° video content 502, the ROI metadata 524, and the specific earcon 536. The VR renderer 518 is similar to the rendering engine 350 of FIG. 3. The VR renderer 518 renders the 360° video content 502 on the HMD 522. The VR renderer 518 also determines whether to play an earcon based on the ROI metadata 524. In certain embodiments, the determination as to whether to play an earcon can be based on the viewing direction of the user within the 360-degree video content 502 coupled with the position information for the region of interest. For example, if the user is currently viewing the ROI, there is no need to play an earcon to guide the user to the ROI. In certain embodiments, the determination as to whether to play an earcon can be based on the timing information for the ROI. For example, if the user is viewing a content that is not in real time, such as a video, the ROI may only be visible at one or more time intervals. When the ROI is visible at only certain time intervals, determination as to whether to play an earcon can be based on whether the ROI is present within the 360° video content 502. If the VR renderer 518 determines to play an earcon, based on the FOV of the VR content currently displayed to the user and the ROI metadata 524, then VR renderer 518 plays the specific earcon 536. In certain embodiments, the VR renderer 518 can also modify one or more attributes of the earcon to guide the user to the ROI.

FIGS. 6A and 6B illustrate an example information transmission of an earcon in accordance with an embodiment of this disclosure. FIG. 6A illustrates an example block diagram of an audio decoder when each earcon is transmitted as an individual audio track. FIG. 6B illustrates an example block diagram of an audio decoder when the earcons are transmitted as a single audio track. Other embodiments can be used without departing from the scope of the present disclosure.

In certain embodiments, the earcon generator 506 of FIG. 5A can generate various versions of the earcon. For example, the earcon can be stored in a look up table. For instance, each earcon is located on a look up table associated with both a transmitter and a receiver, similar to FIGS. 5A and 5B respectively. In another instance, the look up table containing the earcons is transmitted to a receiver as a preamble. In another example, the earcon generator 506 can generates earcon waveforms that are contained in separate audio tracks and transmitted individually to the receiver of FIG. 5B. That is, each earcon has its own audio track. In another example, the earcon generator 506 includes all the earcons in a single audio track, and the single audio track is transmitted to the receiver of FIG. 5B. Each earcon in the single audio track has a unique time instance. Each earcon corresponding to a specific ROI is extracted from the single audio track based on a time stamp associated with the ROI. Stated differently, when a ROI is able to be displayed the earcon that is associated with the ROI is extracted based on the unique time instance of the earcon.

When a look up table is associated with both a transmitter and a receiver or when the look up table containing the earcons is transmitted to a receiver as a preamble the following syntax can be used:

Syntax:

Class RoiEarconSample( ) extends
RegionOnSphereSample {

unsigned int(4) earcon_id;
bit(4) reserved = 0;

}

In the above example, the syntax is extended to include information about the look up table. The earcon_id specifies an earcon from a set of earcons located in the look up table. If the earcon_id is equal to zero, then there are no earcons associated with the ROI.

When each earcon is transmitted in separate audio tracks to the receiver the following syntax can be used:

Syntax:

class EarconSample( ) extends SphereRegionSample {

for (i = 0; i < num_regions; i++)

unsigned int earcon_track_id;
float earcon_gain_factor;

}

In the above example, the syntax is extended to include information about each earcon track. The earcon_track_id specifies the identification number of the earcon audio track that is associated with the sphere region. For example, the track identification is used to select the earcon track from the audio track. In another example, if no earcon track is associated with an ROI then a value of zero is used. The earcon_gain_factor specifies the gain factor of the earcon. In certain embodiments, the gain factor is the attribute that relates to the gain of the audio, such as loudness. In certain embodiments if the earcon_gain_factor is zero then there are no earcons associated with the ROI. In certain embodiments, a flag can indicate whether an earcon is associated with the ROI. For example, the metadata can include a flag that indicates whether to play an earcon or not to play an earcon.

FIG. 6A depicts audio environment 600A. Audio environment 600A illustrates the scenario when each earcon is transmitted in separate audio tracks to a receiver, as described by the above syntax. Bit stream 602A includes the earcon waveforms that are located in separate audio tracks. The audio decoder 604A receives the bit stream 602A and decodes the audio of each earcon. Each earcon is then forwarded to the earcon selector 606A. The earcon selector 606A also receives the earcon earcon_track_id 612A from the above syntax. The earcon_track_id 612A specifies the identification number of the earcon audio track. The earcon selector 606A selects an earcon track from the one or more received audio tracks based on the earcon_track_id 612A. The selected audio for the earcon is then transferred to the object renderer 608A. The object renderer 608A also receives a gain_factor 614A, from the above syntax, the ROI metadata 616A, and a channel layout 618A. The gain_factor 614A specifies a gain parameter of the earcon when the earcon is played. For example, gain_factor 614A can relate the loudness of the earcon when the earcon is played. The ROI metadata 616A identifies the position of the ROI within the VR content. In certain embodiments, the position of the ROI within the VR 360° video content is defined based on the azimuth and elevation set at the center of the ROI. The channel layout 618A specifies the number of output audio channels. For example, if the output is in stereo then only two output transmissions are created by the object renderer 608A for each selected earcon audio track. In another example, if the output is surround sound, such as through five speakers, where each speaker receives a different channel, then five output transmissions are created by the object renderer 608A for each selected earcon audio track.

In certain embodiments, the audio for each earcon is located in a single audio track. When the earcons are located in a single audio track, a single audio track containing all the earcons is transmitted to the receiver. For example, all the earcons associated with VR content are placed at different time instances in a single audio track. Each earcon in the audio track corresponds to one or more specific ROIs. When the ROI can be rendered on the display, the earcon is extracted from the audio track based on the ROI timestamp, as indicated by the ROI metadata 524 of FIG. 5A. When selecting an earcon from a single audio track based on a time instance, the following syntax can be used:

Syntax:

class EarconSample( ) extends SphereRegionSample {

unsigned int earcon_track_id;
for (i = 0; i < num_regions; i++)

float earcon_gain_factor;

}

In the above example, the syntax is extended to include information about the single audio track that includes multiple earcons. The earcon_track_id specifies the identification number of the audio track containing earcons. For example, the track identification is used to select a track from the audio where the earcons are located. In another example, if no earcon track is associated with the ROIs then a value of zero is used. The earcon_gain_factor specifies the gain factor of the earcon. In certain embodiments, the gain factor is the attribute that relates to the gain of the audio, such as loudness. In certain embodiments if the earcon_gain_factor is zero then there are no earcons associated with the ROI. In certain embodiments, a flag can indicate whether an earcon is associated with the ROI. For example, the metadata can include a flag that indicates whether to play an earcon or not to play an earcon.

FIG. 6B depicts audio environment 600B. Audio environment 600B illustrates the scenario when the earcons are located in a single audio track, and the single audio track is transmitted to the receiver, as described by the above syntax. Bit stream 602B includes a single audio track that contains all the earcons associated with the VR content. The audio decoder 604B receives the bit stream 602B and decodes the audio track of the earcons. In certain embodiments, audio decoder 604B is similar to the audio decoder 604A of FIG. 6A. Each audio track is then forwarded to the earcon audio track selector 606B. Each audio track can include multiple earcons. The earcon audio track selector 606B selects an audio track from the decoded audio track based on the received earcon_track_id 612B. The Earcon_track_id 612B is based on the above syntax. The earcon_track_id 612A specifies the identification number of a particular audio track containing various earcons. The earcon audio track selector 606B selects an earcon track from the one or more received audio tracks based on the earcon_track_id 612B. The selected audio track is then transferred to the earcon waveform extractor 608B. The earcon waveform extractor 608B also receives the ROI metadata 616B. The ROI metadata 616B is similar to the ROI metadata 616A of FIG. 6A. The earcon waveform extractor 608B extracts a particular earcon waveform based on the ROI metadata 616B. In certain embodiments, the ROI metadata 616B includes a timestamp for the ROI. For example, the earcon waveform extractor 608B extracts a particular segment of audio from the received audio track that is based on with the timestamp for the ROI. In certain embodiments, the ROI metadata 616B includes the time interval of the audio to be extracted. For example, the earcon waveform extractor 608B extracts a particular segment of audio from the received audio track that is based on indicated interval of time. For instance, the particular segment of audio can be extracted based on a start time and a duration or a start time and an end time. In another example, the earcon waveform extractor 608B extracts a particular segment of audio from the received audio track that is based on a period of time. The extract audio is then is then transferred to the object renderer 610B. The object renderer 610B is similar to the object renderer 608A of FIG. 6A. The object renderer 610B also receives a gain_factor 614B, from the above syntax, the ROI metadata 616C, and a channel layout 618B. The gain_factor 614B is similar to the gain_factor 614A of FIG. 6A. The gain_factor 614B specifies a gain parameter of the earcon when the earcon is played. ROI metadata 616A is similar to the ROI metadata 616A of FIG. 6A and ROI metadata 616B. The ROI metadata 616C identifies the position of the ROI within the VR content. In certain embodiments, the position of the ROI is defined based on the azimuth and elevation of the center of the ROI. The channel layout 618B specifies the number of output audio channels. For example, if the output is in stereo then only two output transmissions are created by the object renderer 610B for each selected earcon audio track. In another example, if the output is surround sound, such as through five speakers, where each speaker receives a different channel, then five output transmissions are created by the object renderer 610B for each selected earcon audio track.

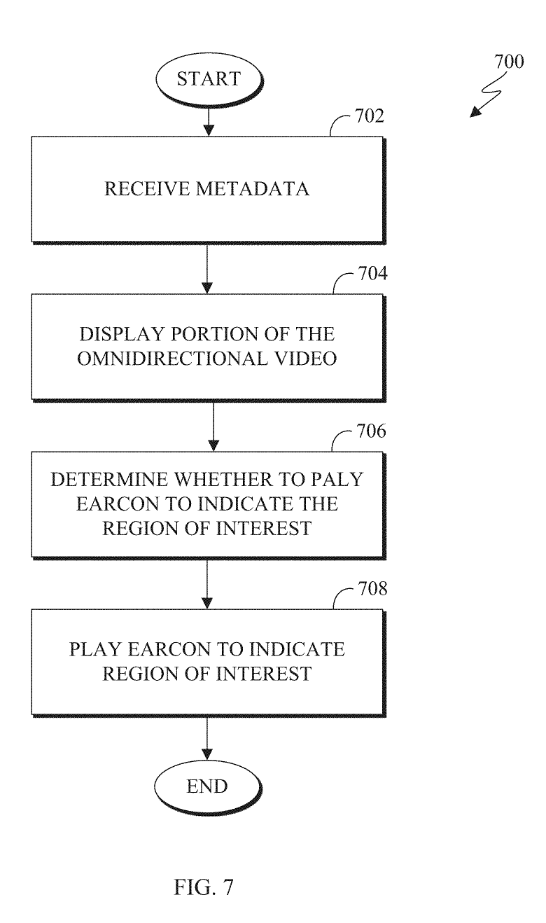

FIG. 7 illustrates an example method for providing an earcon to indicate a region of interest within omnidirectional video content in accordance with embodiments of the present disclosure. FIG. 7 depicts flowchart 700, for indicating a region of interest within omnidirectional video. For example, the process depicted in FIG. 7 is described as implemented by any one of the client devices 106-115 of FIG. 1, the electronic device 200 of FIG. 2, the HMD 300 of FIG. 3, or the HMD 522 of FIG. 5.

The process begins with an electronic device, such as HMD 300 receiving metadata (702). The metadata includes an earcon for the ROI. The metadata also includes timing information for the ROI. The metadata also includes position information for the ROI. The position for the information for the ROI can be based on an azimuth and an elevation location within the omnidirectional video content.

The process displays a portion of the omnidirectional video content on a display (704). The portion of the omnidirectional video content corresponds to the field of view and the viewing direction of the user. In certain embodiments, the process can also determine an orientation of the display. For example, the process can identify whether the position of the ROI is displayed based on the orientation of the display.

The process then determines whether to play the earcon to indicate the ROI (706). The determination as to whether the play the earcon is based on the timing and position information for the ROI. The determination as to whether the play the earcon is also based on the portion of the omnidirectional video content displayed on the display.

If it is determined to play the earcon to indicate the ROI, the process playing audio for the earcon to indicate the ROI (708). In certain embodiments the process can modifying an attribute of the audio for the earcon being played based on changes in the orientation of the display as the display is rotated towards or away from the region of interest. For example, the attribute is gain and can adjust the loudness. In another example, the attribute is frequency and can adjust the pitch. In another example the attribute includes both gain and frequency. When the attribute of the audio is modified the (i) frequency or gain can increase as the orientation of the display is rotated towards the ROI, (ii) frequency or gain can decrease as the orientation of the display is rotated towards the ROI, (iii) frequency or gain can increase as the orientation of the display is rotated away the ROI, and (iv) frequency or gain can decrease as the orientation of the display is rotated away the ROI.

In certain embodiments, playing the earcon can change based on the type of activity the ROI. For example, if the ROI is sports themed, a specific earcon that indicates sports is played. In another example if the ROI is nature themed, a specific earcon that indicates nature can be played.

In certain embodiments, playing the earcon can change based on a recommendation level associated with the ROI. For example, the recommendation level can be based on the author of the omnidirectional video content. In another example, the recommendation level can be based on the number of views a particular ROI has received. In another example, the recommendation level can be based on a derived pattern of the user. The pattern of the type of ROIs that the user views. In certain embodiments, when the earcon is playing a low frequency can indicate a low recommendation level where as a high frequency can indicate a high recommendation level.

In certain embodiments, two or more ROI's can be displayed at the similar time. When multiple ROI's are present within the omnidirectional video content, an earcon can be played that is associated with each ROI. As the orientation of the display moves towards one ROI and away from a second ROI, the earcon associated with the second ROI can be muted while an attribute associated with the earcon associated with the first ROI can be modified. In certain embodiments, each earcons is located (i) in a look up table (ii) in a single audio track or (iii) located in individual audio tracks. When the earcons are located in a look up table, particular earcon associated with a particular ROI is selected and played. The look up table can be local to the HMD 300 or located on a remote server. When the earcons are located in a single audio, the particular earcon associated with a particular ROI is extracted from the audio track and played. For example, the particular earcon is extracted based on a period of time. When each earcon is located in individual tracks, the particular track with the earcon is selected and the audio of that track is played.

Although the figures illustrate different examples of user equipment, various changes may be made to the figures. For example, the user equipment can include any number of each component in any suitable arrangement. In general, the figures do not limit the scope of this disclosure to any particular configuration(s). Moreover, while figures illustrate operational environments in which various user equipment features disclosed in this patent document can be used, these features can be used in any other suitable system.

None of the description in this application should be read as implying that any particular element, step, or function is an essential element that must be included in the claim scope. The scope of patented subject matter is defined only by the claims. Moreover, none of the claims is intended to invoke 35 U.S.C. § 112(f) unless the exact words “means for” are followed by a participle. Use of any other term, including without limitation “mechanism,” “module,” “device,” “unit,” “component,” “element,” “member,” “apparatus,” “machine,” “system,” “processor,” or “controller,” within a claim is understood by the applicants to refer to structures known to those skilled in the relevant art and is not intended to invoke 35 U.S.C. § 112(f).

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. An electronic device for indicating a region of interest within omnidirectional video content, the electronic device comprising:
a receiver configured to receive metadata for the region of interest in the omnidirectional video content, the metadata including an earcon for the region of interest, timing information for the region of interest, position information for the region of interest, and a flag indicating whether to play the earcon;
a display configured to display a portion of the omnidirectional video content on a display;
speakers configured to play audio for the earcon to indicate the region of interest; and
a processor operably coupled to the receiver, the display, and the speakers, the processor configured to determine whether to play the earcon to indicate the region of interest based on whether the flag indicates to play the earcon, the timing and position information for the region of interest, and the portion of the omnidirectional video content displayed on the display.

2. The electronic device of claim 1, wherein the processor is further configured to:
determine an orientation of the display; and
modify an attribute of the audio for the earcon being played based on changes in the orientation of the display as the display is rotated towards or away from the region of interest,
wherein the attribute is at least one of gain or frequency of the audio for the earcon, and
wherein to modify the attribute, the processor is further configured to increase at least one of the gain or the frequency of the audio as the display is rotated towards the region of interest, and decrease at least one of the gain or the frequency of the audio as the display is rotated away from the region of interest.

3. The electronic device of claim 1, wherein to play the audio for the earcon, the processor is further configured to play a type of audio for the earcon to indicate a type of activity of the region of interest, wherein the type of audio includes at least one of an audio sound, gain, or frequency.

4. The electronic device of claim 1, wherein to play the audio for the earcon, the processor is further configured to play a type of audio for the earcon to indicate a type of activity of the region of interest, wherein the type of audio for the earcon corresponds to multiple types of activity; and
wherein the processor is further configured to modify an attribute of the type of audio for the earcon being played based on changes in an orientation of the display as the display is rotated towards or away from the region of interest, wherein the attribute is at least one of gain or frequency of the audio for the earcon.

5. The electronic device of claim 1, wherein:
to play the audio for the earcon, the processor is further configured to play a type of audio for the earcon to indicate a recommended region of interest, wherein the type of audio for the earcon is a high frequency that corresponds to a first recommended region of interest, and the type of audio for the earcon is a low frequency that corresponds to a second recommended region of interest; and
the processor is further configured to modify an attribute of the audio for the earcon being played based on changes in an orientation of the display as the display is rotated towards or away from the region of interest, wherein the attribute is at least one of gain or frequency of the audio for the earcon.

6. The electronic device of claim 1, wherein:
the earcon is a first earcon, the region of interest is a first region of interest, the metadata further includes a second earcon for a second region of interest in the omnidirectional video content, and to play the audio for the first earcon the processor is further configured to play audio for the second earcon to indicate the second region of interest, and
the processor is further configured to:
modify an attribute of the audio for the first earcon and the second earcon being played based on changes in an orientation of the display as the display is rotated towards or away from the first region of interest or the second region of interest, wherein the attribute is at least one of gain or frequency of the audio for the first and second earcon,
increase the attribute of the audio of the first earcon as the display is rotated towards the first region of interest; and
decrease the attribute of the audio of the second earcon as the display is rotated away the second region of interest.

7. The electronic device of claim 1, wherein the processor is further configured to:
identify the earcon from an audio file that includes a plurality of earcons, wherein the earcon is identified by a period of time, and
extract the earcon from the audio file.

8. The electronic device of claim 1, wherein the region of interest is based on an azimuth and an elevation location within the omnidirectional video content; and
wherein the processor is further configured to select the earcon to play from a look-up table.

9. A method for indicating a region of interest within omnidirectional video content, the method comprising:
receiving metadata for the region of interest in the omnidirectional video content, the metadata including an earcon for the region of interest, timing information for the region of interest, position information for the region of interest, and a flag indicating whether to play the earcon;
displaying a portion of the omnidirectional video content on a display;
determining whether to play the earcon to indicate the region of interest based on whether the flag indicates to play the earcon, the timing and position information for the region of interest, and the portion of the omnidirectional video content displayed on the display; and
playing audio for the earcon to indicate the region of interest.

10. The method of claim 9, further comprising:
determining an orientation of the display;
modifying an attribute of the audio for the earcon being played based on changes in the orientation of the display as the display is rotated towards or away from the region of interest;
wherein the attribute is at least one of gain or frequency of the audio for the earcon, and
wherein modifying the attribute further comprises: increasing at least one of the gain or the frequency of the audio as the display is rotated towards the region of interest; and decreasing at least one of the gain or the frequency of the audio as the display is rotated away from the region of interest.

11. The method of claim 10, wherein playing the audio for the earcon further comprises playing a type of audio for the earcon to indicate a type of activity of the region of interest, wherein the type of audio includes at least one of an audio sound, gain, or frequency.

12. The method of claim 9, wherein:
playing the audio for the earcon further comprises playing a type of audio for the earcon to indicate a type of activity of the region of interest, wherein the type of audio for the earcon corresponds to multiple types of activity; and
the method further comprises modifying an attribute of the type of audio for the earcon being played based on changes in an orientation of the display as the display is rotated towards or away from the region of interest, wherein the attribute is at least one of gain or frequency of the audio for the earcon.

13. The method of claim 9, wherein:
playing the audio for the earcon further comprises playing a type of audio for the earcon to indicate a recommended region of interest, wherein the type of audio for the earcon is a high frequency that corresponds to a first recommended region of interest, and the type of audio for the earcon is a low frequency that corresponds to a second recommended region of interest; and
the method further comprises modifying an attribute of the audio for the earcon being played based on changes in an orientation of the display as the display is rotated towards or away from the region of interest, wherein the attribute is at least one of gain or frequency of the audio for the earcon.

14. The method of claim 9, wherein:
the earcon is a first earcon, the region of interest is a first region of interest, the metadata further includes a second earcon for a second region of interest in the omnidirectional video content, and playing the audio for the first earcon further comprises playing audio for the second earcon to indicate the second region of interest, and
the method further comprises:
modifying an attribute of the audio for the first earcon and the second earcon being played based on changes in an orientation of the display as the display is rotated towards or away from the first region of interest or the second region of interest, wherein the attribute is at least one of gain or frequency of the audio for the first and second earcon;
increasing the attribute of the audio of the first earcon as the display is rotated towards the first region of interest; and
decreasing the attribute of the audio of the second earcon as the display is rotated away the second region of interest.

15. The method of claim 9, wherein playing the audio for the earcon further comprises:
identifying the earcon from an audio file that includes a plurality of earcons, wherein the earcon is identified by a period of time, and
extracting the earcon from the audio file.

16. The method of claim 9, wherein the region of interest is based on an azimuth and an elevation location within the omnidirectional video content, and
wherein the method further comprises selecting the earcon to play from a look-up table.

17. A non-transitory computer readable medium embodying a computer program, the computer program comprising computer readable program code that when executed by a processor of an electronic device causes processor to:
receive metadata for a region of interest in an omnidirectional video content, the metadata including an earcon for the region of interest, timing information for the region of interest, position information for the region of interest, and a flag indicating whether to play the earcon;
display a portion of the omnidirectional video content on a display;
determine whether to play the earcon to indicate the region of interest based on whether the flag indicates the play the earcon, the timing and position information for the region of interest, and the portion of the omnidirectional video content displayed on the display; and
play audio for the earcon to indicate the region of interest.

18. The non-transitory computer readable medium of claim 17, further comprising program code that, when executed at the processor, causes the processor to:
determine an orientation of the display;
modify an attribute of the audio for the earcon being played based on changes in the orientation of the display as the display is rotated towards or away from the region of interest; and
wherein the attribute is at least one of gain or frequency of the audio for the earcon.

19. The non-transitory computer readable medium of claim 17, further comprising program code that, when executed at the processor, causes the processor to:
play a type of audio for the earcon to indicate a type of activity of the region of interest, wherein the type of audio for the earcon corresponds to multiple types of activity; and
modify an attribute of the type of audio for the earcon being played based on changes in an orientation of the display as the display is rotated towards or away from the region of interest, wherein the attribute is at least one of gain or frequency of the audio for the earcon.

20. The non-transitory computer readable medium of claim 17, further comprising program code that, when executed at the processor, causes the processor to:
play a type of audio for the earcon to indicate a recommended region of interest, wherein the type of audio for the earcon is a high frequency that corresponds to a first recommended region of interest, and the type of audio for the earcon is a low frequency that corresponds to a second recommended region of interest; and
modify an attribute of the audio for the earcon being played based on changes in an orientation of the display as the display is rotated towards or away from the region of interest, wherein the attribute is at least one of gain or frequency of the audio for the earcon.
